(19) United States
(12) Patent Application Publication
(10) Pub. No.: US 2026/0222825 A1
(43) Pub. Date: Jul. 30, 2026

(54) OPTIMIZED ACCESS POINT DEPLOYMENT AND BLUEPRINT VALIDATION

(71) Applicant: Cisco Technology, Inc., San Jose, CA (US)

(72) Inventors: Vijay S REDDY, Foster City, CA (US); Peiman AMINI, Fremont, CA (US); Naveen Kumar TYAGI, Fremont, CA (US); Ardalan ALIZADEH, Campbell, CA (US); Khanh V NGUYEN, MILPITAS, CA (US)

(21) Appl. No.: 19/036,909

(22) Filed: Jan. 24, 2025

(51) Int. Cl. H04W 16/20; H04L 41/22

(52) U.S. Cl. CPC H04W 16/20; H04L 41/22

(57) ABSTRACT

In one embodiment, a method for optimized access point deployment and blueprint validation can include obtaining, by a process, a floorplan of a given location within which one or more access points are to be installed and determining, by the process and based on historical information, effects of environmental features within the given location on wireless communication coverage based on the floorplan. The method can further include determining, by the process, specific placement of each of the one or more access points within the given location to maximize the wireless communication coverage based on the effects, and producing, by the process, a recommendation of the specific placement on the floorplan.

### TECHNICAL FIELD

The present disclosure relates generally to computer networks, and, more particularly, to optimized access point deployment and blueprint validation.

### BACKGROUND

In general, deploying and upgrading wireless networks involves a complex, error-prone process that requires significant manual effort. Customers must determine the number of access points (APs) to install, manually place them according to a blueprint, and validate their positions, often leading to inefficiencies and potential misplacements. Additionally, when upgrading from older AP models, it is challenging to optimize the placement of new APs without extensive manual site surveys.

Some approaches seek to mitigate the inevitable issues that come with deploying and upgrading wireless networks in various ways. These approaches often rely on information calculated solely on positions provided by Global Navigation Satellite System (GNSS) receivers to calculate the relative positions of the APs in the network deployment.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIGS. 3A-3C illustrate examples of locating access points in campus settings, building settings, and floor settings;

FIGS. 4-1 and 4-2 illustrate an example of a system for advanced security through anomaly detection and locating in wireless networks in accordance with the disclosure; and

FIG. 5 illustrates an example procedure for optimized access point deployment and blueprint validation.

### DESCRIPTION OF EXAMPLE EMBODIMENTS

### Overview

According to one or more embodiments of the disclosure, a method for optimized access point deployment and blueprint validation can include obtaining, by a process, a floorplan of a given location within which one or more access points are to be installed and determining, by the process and based on historical information, effects of environmental features within the given location on wireless communication coverage based on the floorplan. The method can further include determining, by the process, specific placement of each of the one or more access points within the given location to maximize the wireless communication coverage based on the effects, and producing, by the process, a recommendation of the specific placement on the floorplan.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

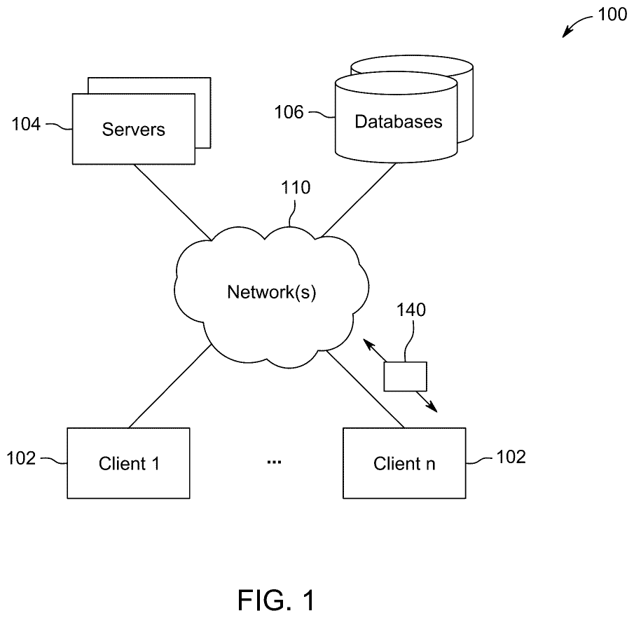

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

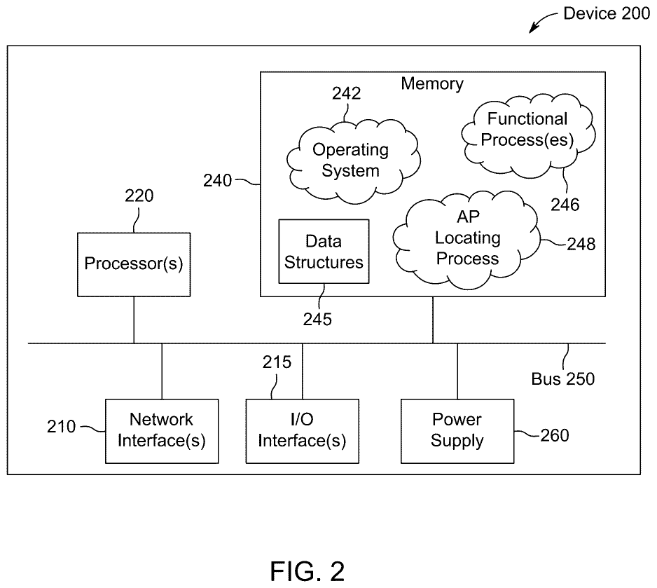

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an AP locating process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, one or more functional processes 246 and/or AP locating process (process 248) may include computer executable instructions that, when executed by processor(s) 220, cause device 200 to perform the techniques described herein. To do so, in some implementations, one or more functional processes 246 and/or process 248 may utilize machine learning. In various implementations, one or more functional processes 246 and/or process 248 may employ one or more supervised, unsupervised, or semi-supervised machine learning models.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Optimized Access Point Deployment and Blueprint Validation

As noted above, deploying and upgrading wireless networks involves a complex, error-prone process that requires significant manual effort. Customers must determine the number of access points (APs) to install, manually place them according to a blueprint, and validate their positions, often leading to inefficiencies and potential misplacements. Additionally, when upgrading from older AP models, it is challenging to optimize the placement of new APs without extensive manual site surveys.

The techniques herein therefore provide for the deployment and upgrade of wireless networks using a network management tool (e.g., Catalyst Center® or other suitable network management tool) with the aim to streamline and enhance the accuracy of AP placement. Several different aspects for the deployment and upgrade of wireless networks are presented herein: (1) Incremental Validation with AP Auto Locate; (2) Real-Time Blueprint Enhancement Using AP-to-AP Ranging; (3) Optimized AP Placement During Upgrades; and (4) Machine Learning-Driven Predictive AP Placement. Together, these aspects, which are discussed in greater detail, herein, can significantly reduce manual effort, improve the accuracy of AP placements, and enhance overall network performance in comparison to previous approaches, thereby providing a seamless and intelligent deployment experience for network installers and network administrators.

Some implementations described herein can utilize auto locating tools (e.g., AutoLocate® by Cisco Systems, Inc.®, or other suitable AP locating tool) that employ a combination of GNSS raw data and ranging FTM (Fine Timing Measurement) data to position the APs with precision onto the floor map. This integration of cutting-edge positioning technologies not only ensures the accuracy of AP placement but also facilitates seamless integration with existing floor maps, providing users with a comprehensive visual representation of their network infrastructure. In the following sections, we dive deeper into the intricate details of the AP positioning process explaining algorithms and methodologies employed by the disclosure to provide these and other features.

As discussed in more detail, herein, techniques of the disclosure introduce a comprehensive, data-driven approach to wireless network deployment that significantly reduces manual effort and enhances the accuracy of access point (AP) placement. Traditional methods generally rely on manual site surveys, static simulations, and generalized assumptions about environmental conditions, often leading to suboptimal performance and increased costs due to their inability to account for unique environmental characteristics.

In contrast, aspects of the present disclosure employ incremental validation with AP auto locating tools, enabling real-time verification of each AP's placement during installation. This immediate feedback allows installers to correct discrepancies on the spot, preventing errors from propagating—a proactive feature not present in conventional methods that typically validate placements only after full deployment.

Further, the system disclosed herein dynamically adjusts deployment blueprints using real-time AP-to-AP ranging data, reflecting actual environmental conditions and ensuring optimal coverage. During network upgrades, the system(s) disclosed herein leverage historical deployment data and client behavior analytics to optimize new AP placements without requiring extensive manual intervention. Finally, the use of machine learning algorithms trained on extensive historical data provides customized, efficient deployment strategies tailored to new environments, surpassing current tools that offer only generic predictive planning.

Further, in contrast to some approaches, aspects of the present disclosure adopt a more advanced methodology that utilizes GNSS raw data alongside the precise location information of satellites as fixed anchors. By integrating this comprehensive dataset with ranging data, methodologies in accordance with the disclosure can determine the positions of APs with a much higher accuracy as compared to previous approaches. Moreover, by leveraging this robust combination of data sources, methodologies in accordance with the disclosure mitigate error propagation and significantly improve the overall accuracy and reliability of AP localization.

Specifically, according to one or more embodiments of the disclosure as described in detail below, a method for optimized access point deployment and blueprint validation can include obtaining, by a process, a floorplan of a given location within which one or more access points are to be installed and determining, by the process and based on historical information, effects of environmental features within the given location on wireless communication coverage based on the floorplan. The method can further include determining, by the process, specific placement of each of the one or more access points within the given location to maximize the wireless communication coverage based on the effects, and producing, by the process, a recommendation of the specific placement on the floorplan.

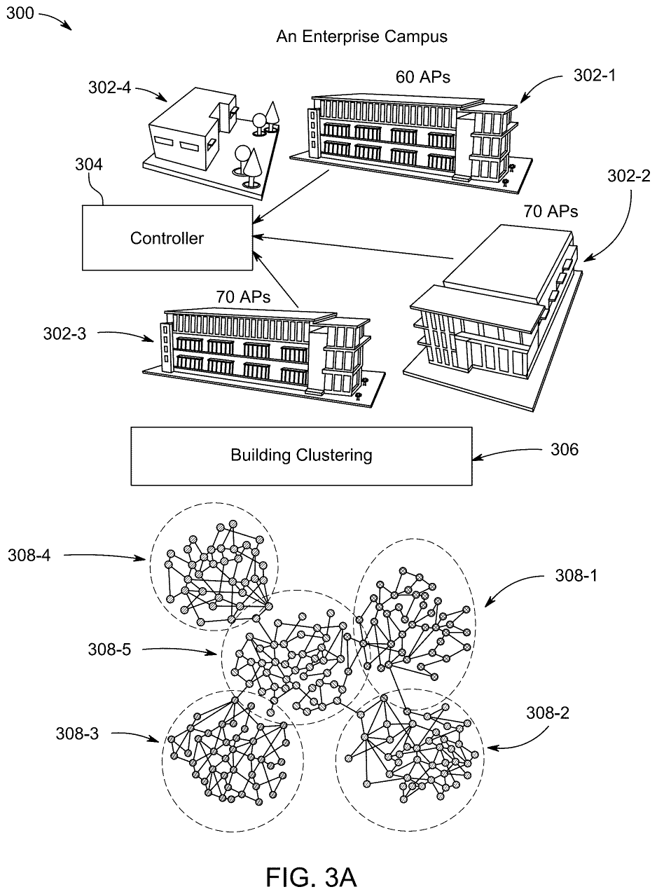

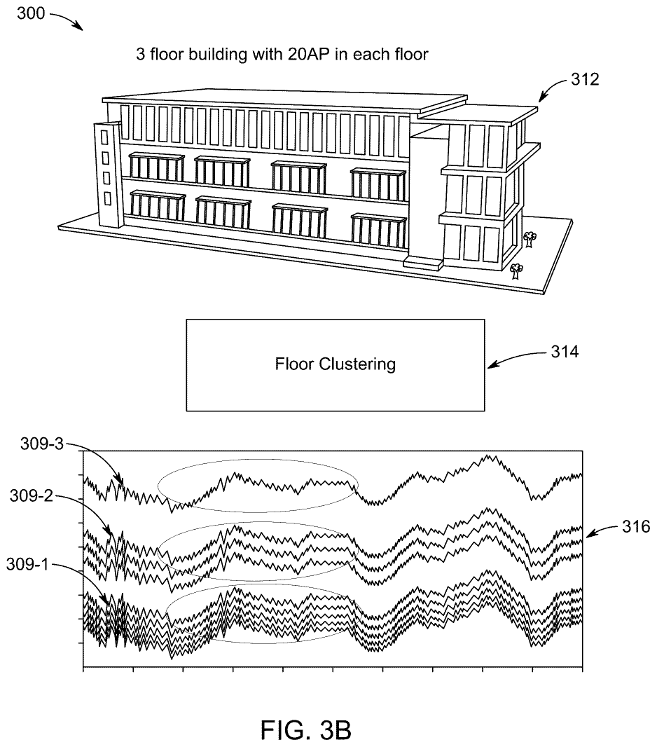

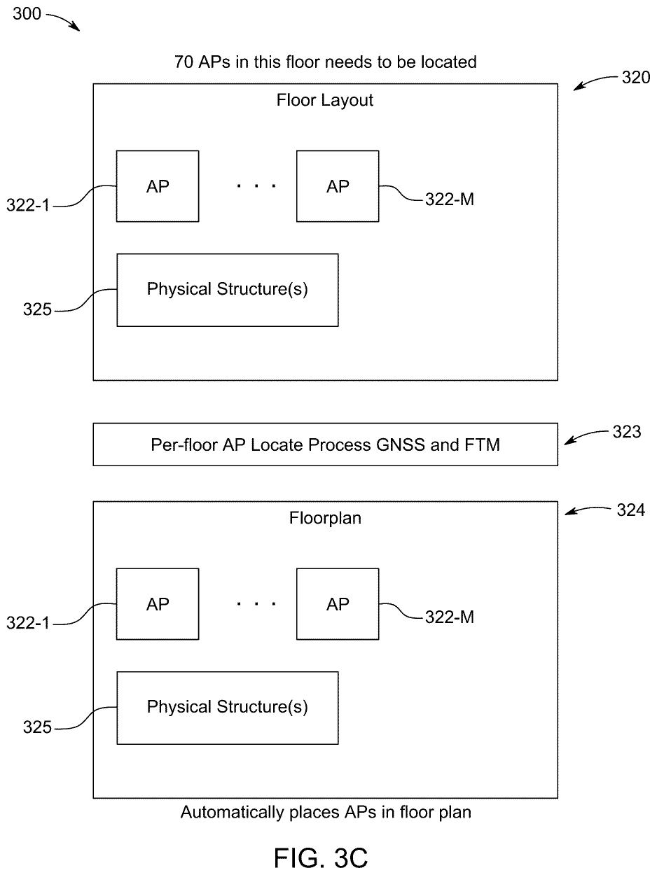

Operationally, FIGS. 3A-3C illustrate examples of locating access points in campus settings, building settings, and floor settings. In particular, FIG. 3A illustrates an example of locating access points in campus settings, FIG. 3B illustrates an example of locating access points in building settings, and FIG. 3C illustrates an example of locating access points in building settings floor settings.

As shown in FIG. 3A, a system 300 (e.g., an enterprise campus network) includes four buildings (e.g., a first building 302-1, a second building 302-2, a third building 302-3, and a fourth building 302-4). It will be appreciated that implementations herein are not limited to a particular quantity or number of buildings and implementations herein contemplate enterprise campus networks that include greater than four buildings or fewer than four buildings. A controller 304 (or one or more controllers) can be deployed in the system 300 and may be coupled to network devices (e.g., routers, APs, network switches, etc.). In some implementations, the controller 304 can be an SDN controller, although implementations are not so limited.

Using building clustering 306 techniques, a cluster map can be generated showing the communication between the various network devices. In the example of FIG. 3A, this cluster map may include a first cluster 308-1 (which can be associated with the first building 302-1), a second cluster 308-2 (which can be associated with the second building 302-2), a third cluster 308-3 (which can be associated with the third building 302-3), a fourth cluster 308-4 (which can be associated with the fourth building 302-4), and a fifth cluster 308-5 (which can be associated with the outdoor space between the buildings).

As shown in FIG. 3B, a system 300 (e.g., an enterprise network) includes a building 312, such as any of the buildings in FIG. 3A above. The building in FIG. 3B can have floors (e.g., stories), although it will be appreciated that implementations herein are not limited to a particular quantity or number of floors and implementations herein contemplate enterprise networks that include greater than three floors or fewer than three floors. Although not explicitly shown in FIG. 3B, A controller, such as the controller 304 (or one or more controllers) can be deployed in the system 300 and may be coupled to network devices (e.g., routers, APs, network switches, etc.).

Using floor clustering 314 techniques, a cluster map can be generated showing the communication between the various network devices. In the example of FIG. 3B, this cluster map 316 may include a first cluster 309-1 (which can be associated with the first floor of the building 312), a second cluster 309-2 (which can be associated with the second floor of the building 312), and a third cluster 309-3 (which can be associated with third floor of the building 312).

As shown in FIG. 3C, a system 300 (e.g., an enterprise network) includes a floor layout 320 that can include a plurality of APs (e.g., a first AP 322-1 through an M^{th} AP 322-M), such as a particular floor of the building shown in FIG. 3B above. The floor layout 320 can further include physical structure(s) 325. As an example, the floor layout 320 can represent a floor of an office building showing locations of multiple APs on that particular floor. The physical structure(s) 325 can include walls, room dividers, desks, water coolers, support pillars, and so on and so forth that may be present on the floor of an office building.

A per-floor AP locating process using GNSS raw data and ranging FTM (Fine Timing Measurement) data can be employed at block 323 in order to generate a floorplan 324. The floorplan 324 can include the physical structure(s) 325 that are present on the floor of the building in addition to the plurality of APs (e.g., the first AP 322-1 through the M^{th} AP 322-M), however, the relative positioning of the plurality of APs may be different in the floorplan 324 than in the floor layout 320. That is, the relative positioning of the plurality of APs in the floorplan 324 can be determined and/or optimized using the techniques described herein to provide a safer and better provisioned network than a network that relies on the floor layout 320.

In the examples of FIGS. 3A-3C, a locating process (e.g., AP locating process (process 248), which can be provided by AutoLocate® or other similar process) can be employed to precisely locate APs at the campus, building, and floor level, thereby improving the management of wireless AP networks on a large scale. As shown in FIGS. 3A-3C, such a process can utilize a sophisticated building clustering algorithm to categorize APs into specific buildings within a campus environment. Once the APs are identified within their respective buildings, the system seamlessly transitions to the floor clustering algorithm, meticulously determining the exact floor where the desired APs are located.

In accordance with the disclosure, this process employs a combination of GNSS raw data and ranging FTM (Fine Timing Measurement) data to position the APs with a high level of precision onto the floorplan 324. This integration of cutting-edge positioning technologies not only ensures the accuracy of AP placement but also facilitates seamless integration with existing floor layouts, providing users with a comprehensive visual representation of their network infrastructure. More specific details involving the AP positioning process and explanations of the algorithms and methodologies employed to achieve accuracy and reliability in the network are described herein.

FIGS. 4-1 and 4-2 illustrate an example of a system for advanced security through anomaly detection and locating in wireless networks in accordance with the disclosure. The system 400 shown in FIGS. 4-1 and 4-2 includes a plurality of GNSS satellites (e.g., a first GNSS 420-1, a second GNSS 420-2, a third GNSS 420-3, and a fourth GNSS 420-4) that are communicatively coupled to a plurality of access points (e.g., a first AP 422-1, a second AP 422-2, a third AP 422-3, and a fourth AP 422-4). It will be appreciated that the quantity of GNSS and or APs can be greater than or fewer than four and the example of FIGS. 4-1 and 4-2 is merely illustrative.

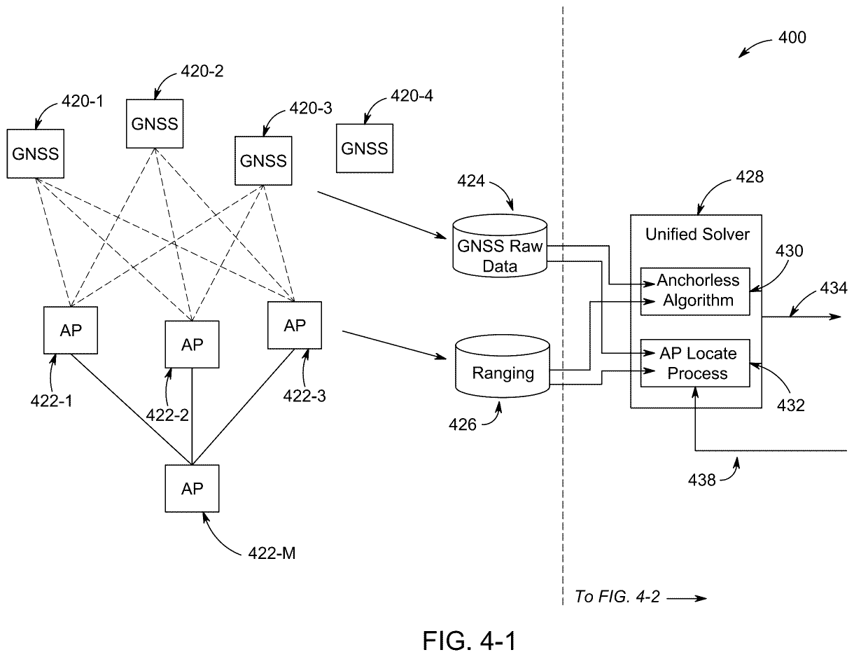

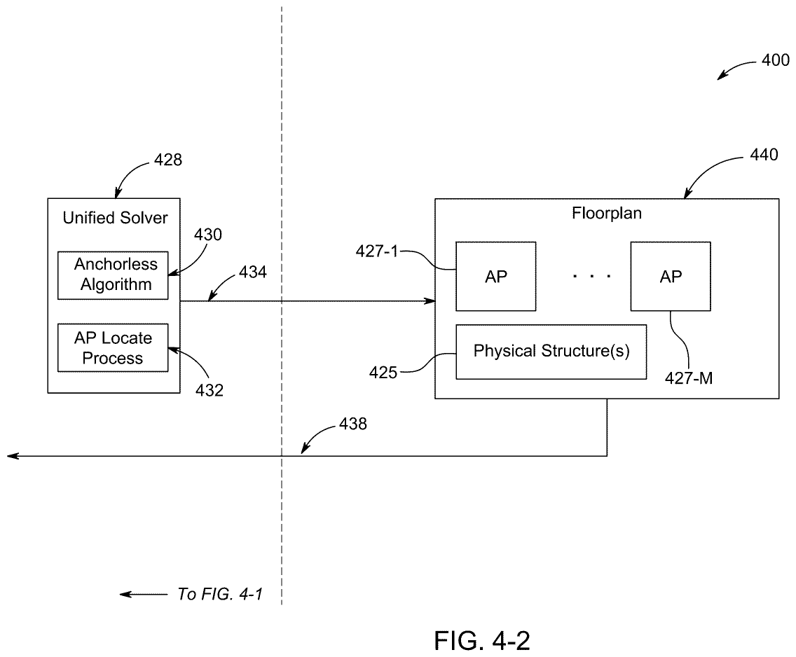

As shown in FIG. 4-1, data from the plurality of GNSS satellites (i.e., GNSS raw data 424) can be collected while ranging data 426 (e.g., ranging FTM) can be collected from the plurality of APs. The GNSS raw data 424 and the ranging data 426 can be provided to a unified solver 428. More specifically, GNSS raw data 424 and the ranging data 426 can be provided to an anchorless algorithm 430 and an AP locate process 432, which are deployed within the unified solver 428. The unified solver 428 can process data output from the anchorless algorithm 430 and the AP locate process 432 via output 434 to the floorplan 440 (illustrated in FIG. 4-2).

As shown in FIG. 4-2, the output 434 can be received to generate the floorplan 440, which can include a plurality of APs (e.g., a first AP 422-1 through an M^{th} AP 422-M) and physical structure(s) 425. In some implementations, the first AP 422-1 through the M^{th} AP 422-M) and physical structure(s) 425 can be analogous to the first AP 322-1 through the M^{th} AP 322-M and the physical structure(s) 325 of FIG. 3C. The floorplan 440 can further be configured to return data (e.g., floorplan data, updated AP data, etc.) to the unified solver 428 via path 438.

Notably, conventional methods rely on the calculated positions provided by GNSS receivers, where the positions of APs are calculated using GNSS receivers acting as fixed anchors, and integrating ranging data to those receivers in order to determine the positions of other APs within the network. However, these methodologies are susceptible to error propagation, where the inaccuracies associated with each GNSS receiver's calculated position are compounded, leading to significant inaccuracies in the overall AP positioning. This reliance on calculated positions without GNSS raw data at the AP itself can lead to error accumulation and suboptimal localization.

In contrast, certain implementations described herein may adopt a more advanced methodology that utilizes GNSS raw data alongside the precise location information of satellites as fixed anchors. By integrating this comprehensive dataset with ranging data, implementations described herein determine the positions of APs with much higher accuracy than previous approaches. By leveraging this robust combination of data sources, aspects of the present disclosure mitigate error propagation and significantly improve the overall accuracy and reliability of AP localization.

As mentioned above, implementations herein provide a suite of solutions designed to streamline and enhance the wireless network deployment process using a network management tool. By leveraging advanced technologies such as real-time AP auto location, historical deployment data, and machine learning, the manual effort required to deploy a network can be reduced, the accuracy of AP placements can be improved, and network performance during both initial deployments and upgrades can be optimized.

As mentioned above, the disclosure includes various techniques to facilitate implementations described herein—(1) Incremental Validation with AP Auto Locate; (2) Real-Time Blueprint Enhancement Using AP-to-AP Ranging; (3) Optimized AP Placement During Upgrades; and (4) Machine Learning-Driven Predictive AP Placement. These will be described in more detail below.

### Incremental Validation With AP Auto Locate

When deploying wireless networks, ensuring that each AP is installed in the correct location according to the blueprint is critical for optimal performance. However, some approaches involve waiting until all APs are installed before validating their placement, which can lead to widespread errors if even a single AP is misplaced.

In contrast, implementations described herein may utilize incremental validation using AP auto locating during the installation process. As each AP is installed, its actual location is immediately compared with the blueprint using AP-to-AP ranging data. If a discrepancy is detected, the installer is alerted to correct the placement before proceeding with further installations. This step-by-step validation ensures that errors are caught and corrected early, preventing them from propagating throughout the deployment.

As an example, consider a large office building where APs are being installed on multiple floors. During the installation on the first floor, an AP is placed too close to a support pillar, reducing its effective coverage area. The incremental validation process detects this deviation from the blueprint, alerts the installer, and provides guidance on repositioning the AP. By correcting the error immediately, the installer avoids coverage gaps and ensures that subsequent APs are placed correctly, maintaining the integrity of the network design.

### Real-Time Blueprint Enhancement Using AP-to-AP Ranging

Traditional network planning generally relies on simulations that assume standard material properties for walls, doors, and other obstructions. However, these assumptions can lead to inaccuracies in the predicted network performance because the actual building materials may have different properties.

In contrast, implementations described herein may enhance the deployment blueprint in real-time by incorporating AP-to-AP ranging data collected during installation. As APs are installed, they measure signal propagation and attenuation between each other. In accordance with the disclosure, this real-world data is then used to dynamically adjust the blueprint, accounting for the actual environmental conditions, such as unexpected wall thickness or varying material properties. The updated blueprint ensures optimal coverage and performance, reflecting the true conditions of the deployment environment.

As an example, in a warehouse environment, the initial blueprint assumes standard drywall with a certain attenuation factor. However, during installation, AP-to-AP ranging data reveals that the walls are made of concrete, resulting in higher attenuation than expected. The system disclosed herein can detect this discrepancy, update the blueprint to reflect the actual conditions, and adjust the AP placement to ensure consistent coverage throughout the warehouse.

### Optimized AP Placement During Upgrades

When upgrading from older AP models to newer ones, customers often struggle to optimize the placement of the new APs to meet their current network requirements. The challenge is to leverage existing data to inform the placement of new APs without requiring extensive manual site surveys.

In some implementations, historical data from previous AP deployments and client behavior (possibly from the Internet Content Adaptation Protocol (iCAP)) can be used to optimize the placement of new APs during an upgrade. The system of the disclosure can then analyze past AP locations, signal strength records, and client connection patterns to identify areas where the previous network had issues, such as weak coverage or high interference. The new APs can then be positioned to address these issues, ensuring that the upgraded network performs optimally.

As an example, a university seeks to upgrade from WiFi 6E to WiFi 7 APs. Historical data may show that certain lecture halls had weak signal strength due to their large size and thick walls. Using this information, the system of the disclosure positions the new WiFi 7 APs to provide stronger coverage in these areas, ensuring that students and faculty experience reliable connectivity throughout the campus.

### Machine Learning-Driven Predictive AP Placement

Deploying a wireless network in a new environment typically requires extensive site surveys to determine the optimal number and placement of APs. This manual process is time-consuming and may not account for the unique characteristics of each environment.

In contrast, aspects of the present disclosure can utilize machine learning algorithms trained on historical deployment data, including floor maps, heatmaps, and network performance metrics, to predict the optimal AP configuration for new deployments. The machine learning model disclosed herein can analyze patterns from previous successful deployments and can apply this knowledge to generate a tailored AP placement plan for new environments, reducing the need for manual site surveys and ensuring efficient deployment.

As an example, a new office building is being equipped with a wireless network. Instead of conducting a time-consuming site survey, the system of the disclosure can use machine learning to analyze similar deployments in other office buildings. In this example, the model can predict that the building's layout, combined with the expected user density, will require 30 APs, strategically placed to maximize coverage and minimize interference. This predictive approach speeds up the deployment process and provides a high level of confidence in the network's performance.

To summarize the foregoing, implementations of the present disclosure provide an approach to the deployment and upgrade of wireless networks within a network management tool, such as Catalyst Center®, aiming to streamline and enhance the accuracy of AP placement. As discussed above, four solutions, which can be provided independently or in some combination, are disclosed herein:
Incremental Validation with AP Auto Locate: This method allows for real-time validation of AP placements during installation, correcting errors as they occur, ensuring that the final network configuration adheres to the blueprint.
Real-Time Blueprint Enhancement Using AP-to-AP Ranging: By integrating real-world AP-to-AP ranging data during installation, this approach dynamically refines the deployment blueprint, ensuring it reflects actual building conditions and optimizing network performance.
Optimized AP Placement During Upgrades: Leveraging historical deployment data and client behavior analytics, this solution optimizes the placement of new APs during network upgrades, addressing issues observed in previous configurations.
Machine Learning-Driven Predictive AP Placement: This approach uses machine learning to predict the optimal number and placement of APs for new deployments, reducing the need for manual site surveys and ensuring efficient, data-driven network planning.

Together, these and other techniques described herein can significantly reduce manual effort, improve the accuracy of AP placements, and enhance overall network performance, providing a seamless and intelligent deployment experience for network installers, administrators, and users.

As discussed above, implementations of the present disclosure provide optimized access point deployment and blueprint validation for network deployments by utilizing the capabilities of a network management tool, such as Catalyst Center®. In current approaches, a customer, from the time he or she places the order for the wireless network, and from the time it gets completely onto the ceiling and onto the catalyst center maps, to where someone can do an active monitoring of the APs and perform the heat map generation, it takes close to one month on average. The reason for this is primarily that the customer places the order, then works offline with some other vendors with other expertise to build a blueprint: “Where does that AP go? To the floor? On the ceiling? Where?” Once these types of questions have been answered, the customer will bring contractors, get the contractors onboarded, and get them into the system.

After this process is completed, the contractor can go and begin placing APs and bringing the APs onto the site maps (e.g., floorplans). This step is generally performed manually such that the contractor has to manually place the installed APs onto the site map. However, utilizing the techniques disclosed herein, such as AP auto locating, etc., one or more of these foregoing steps can be performed automatically, thereby reducing time and costs involved with deploying the network.

Further, implementations of the present disclosure allow for scenarios in which, at the time of ordering, if the customer can provide a floor plan of what the space looks like, then based on an order (e.g., a purchase order) for the APs (e.g., what type of APs have been ordered, what radios the APs employ, and/or the different capabilities of APs being ordered, an algorithm can be executed to determine an optimized blueprint for the network deployment. In addition, floorplans may not usually be all that different from one another, although there can be hundreds of variations based on available data from other deployments, implementations of the disclosure can, based on the purchase order for the APs and the floorplan, determine a recommended blueprint showing the optimal locations to install the APs.

For example, using historical data of similar network deployments, the systems described herein can generate a recommended blueprint based on information associated with the APs and the floorplan. In some implementations, this use of historical data can serve as an added layer of confidence because, if a similar deployment with a similar floorplan is operating in an optimized manner, the recommended blueprint should also allow for a network that operates in an optimized manner. These and other features of the present disclosure can reduce the need for the manual labor of trying to locate where those APs are to be placed in the location (e.g., campus, building, etc.). Further, such features of the present disclosure can provide recommendations for the best placement of APs (e.g., in or on the ceiling, etc.) and automatically provide them in the recommended floorplan. This can allow for a reduction in wait time for deployment of the network by simplifying and streamlining the AP selection, ordering, and locating process.

For example, if an office is located on the 12th floor of a given building, a floorplan of the 12^{th} floor of this building is provided, and a customer installing a network in that office buys five particular routers and/or APs, implementations herein can generate a recommended floorplan that shows the exact locations in which these five routers and/or APs should be installed to optimize the coverage of the network. Further, once the installation is complete (or at various stages of the installation), the techniques herein can provide updated recommendations for placement in the location based on real-time data collection, machine learning techniques, and/or historical data.

In addition, as mentioned above, implementations herein provide for a learning aspect where, for example, a map of millions of APs in the field (e.g., ten million, twenty million, etc.) connected to various management systems. In some scenarios it may be possible to know where the APs are located and, in some scenarios, it may not be possible to know where the APs are located. However, using machine learning techniques in accordance with the disclosure, it can be possible to figure out how people would typically place an AP, and whether that configuration works or not.

As an example, assume a customer has one hundred buildings and they have two AP models, and this is how they placed them. So now the customer obtains a hundred and first building. Based on the building type and the historically learned deployments, there is some information to be learned from the previous deployments that can be applied to the new one. With the learned data, relative to before where someone would have to manually place them, aspects herein allow for automation, so installers know where to place the APs and can confirm that's where they were placed (e.g., by validation against the original blueprint after the installer places it, etc.).

Although implementations herein have been generally described in terms of enterprise deployments (e.g., campus deployments, office building deployments, etc.), the techniques can also be applied to outdoor situations and/or personal installations, such as mesh devices in a house or other smaller scale localized network deployment. For example, using the techniques herein, optimal personal/home device placement can also be determined. This could prevent under-engineering or over-engineering, and can simplify the process of determining where to place APs in these scenarios as well.

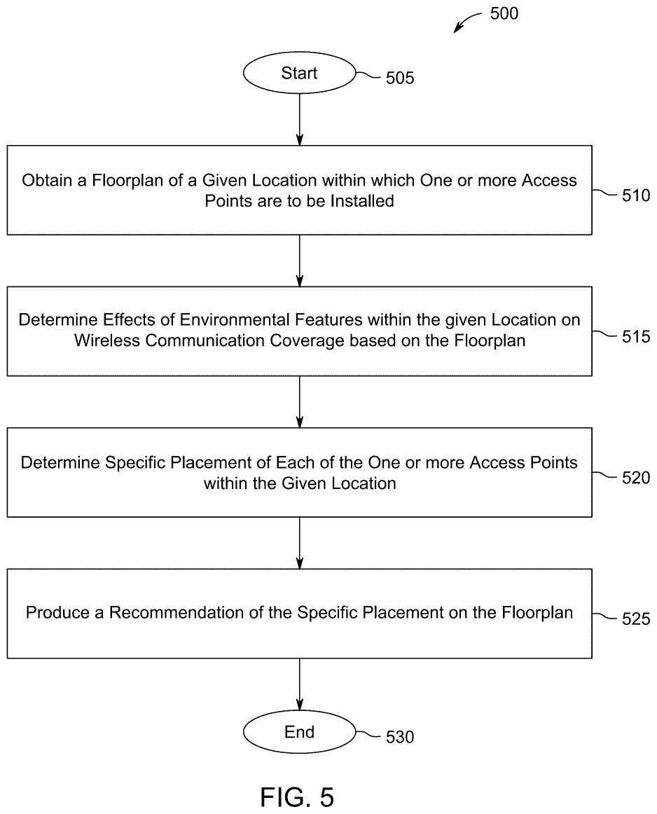

In closing, FIG. 5 illustrates an example procedure for optimized access point deployment and blueprint validation in accordance with one or more embodiments described herein, particularly from the perspective of a device. For example, a non-generic, specifically configured device (e.g., device 200, an apparatus) may perform procedure 500 by executing stored instructions (e.g., process 248). The procedure 500 may start at step 505, and continues to step 510, where, as described in greater detail above, a floorplan of a given location within which one or more access points are to be installed is obtained.

In some implementations, the one or more access points to be installed are additional access points to an existing deployment of previously installed access points within the given location. Implementations are not so limited, however, and in some implementations, the one or more access points to be installed are new access points for a new deployment within the given location without keeping any previously installed access points at the given location. In yet other implementations, the one or more access points to be installed comprise at least one upgraded replacement access point for one or more existing access points of an existing deployment within the given location.

Procedure 500 continues to step 515 where, as described in greater detail above, effects of environmental features within the given location on wireless communication coverage based on the floorplan are determined based on historical information. In some implementations, the historical information includes environmental information based, at least in part, on observations from a legacy access point deployment within the given location. Implementations are not so limited, however, and in some implementations, the historical information includes access point coverage information that is based, at least in part, on signal strength measurements, client connection patterns, ranging data, or any combination thereof. In still other implementations, the historical information includes information corresponding to expected access point behavior based on specifications associated with a particular access point, expected access point behavior based on simulations associated with the particular access point, or any combination thereof.

Procedure 500 continues to step 520 where, as described in greater detail above, specific placement of each of the one or more access points within the given location to maximize the wireless communication coverage based on the effects is determined. In some implementations, the specific placement is determined based on information selected from a group consisting of: a determined configuration of the one or more access points, a determined type of the one or more access points, and the determined configuration of the one or more access points and the determined type of the one or more access points. In addition to, or in the alternative, procedure 500 can further include determining, by the process, a pre-configured number of access points to be deployed within the given location and determining, by the process, the specific placement of each of the one or more access points given the pre-configured number of access points to be deployed within the given location.

Procedure 500 continues to step 525 where, as described in greater detail above, a recommendation of the specific placement on the floorplan is produced. In some implementations, procedure 500 can further include determining, by the process, a calculated number of access points to use within the given location based on the floorplan and the effects. In some implementations, the floorplan of the given location can comprise a changed floorplan as compared to a previous floorplan of the given location, and wherein the one or more access points to be installed comprise existing access points of an existing deployment within the given location.

In some implementations, the procedure 500 can further include determining, by the process, a location of a particular access point of the one or more access points after installation of the particular access point, validating, by the process, the location of the particular access point after installation against the recommendation of the specific location on the floorplan, and generating, by the process, an incremental report that either confirms the location of the particular access point against the recommendation or alerts that the location of the particular access point is different than the recommendation.

The procedure 500 can further include determining, by the process, a pre-set budget for deploying the one or more access points within the given location and determining, by the process and based at least in part on the pre-set budget, one or more of: a calculated number of access points to use within the given location, a type of the one or more access points, and a configuration of the one or more access points.

In some implementations, the procedure 500 can further include performing one or more tests involving a particular access point installed according to the recommendation of the specific placement on the floorplan, determining, based on a result of the one or more tests, that the particular access point is experiencing an unexpected condition, determining, by the process, a new placement for the particular access point in response to the result of the one or more tests, and providing, by the process, a new recommended placement for deployment of the particular access point.

The procedure 500 can further include processing, using machine learning techniques, a plurality of access point deployments within various floorplan designs to determine guidance for successful access point deployment, wherein the historical information includes the guidance for successful access point deployment as applied to the floorplan of the given location.

The procedure 500 can further include integrating real-world AP-to-AP ranging data during installation enhancing the deployment blueprint. In such implementations, the real-world data is used to dynamically adjust the blueprint, accounting for the actual environmental conditions (such as unexpected wall thickness or varying material properties) and optimizing network performance. In addition to, or in the alternative, the procedure 500 can further include analyzing past AP locations, signal strength records, and client connection patterns to identify areas where the previous network had issues (such as weak coverage or high interference).

Procedure 500 may end at step 530.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: obtaining a floorplan of a given location within which one or more access points are to be installed; determining, based on historical information, effects of environmental features within the given location on wireless communication coverage based on the floorplan; determining specific placement of each of the one or more access points within the given location to maximize the wireless communication coverage based on the effects; and producing a recommendation of the specific placement on the floorplan.

In still other implementations, a tangible, non-transitory, computer-readable medium storing program instructions that cause a device to execute a process comprising: obtaining a floorplan of a given location within which one or more access points are to be installed; determining, based on historical information, effects of environmental features within the given location on wireless communication coverage based on the floorplan; determining specific placement of each of the one or more access points within the given location to maximize the wireless communication coverage based on the effects; and producing a recommendation of the specific placement on the floorplan.

The techniques described herein, therefore, provide for optimized access point deployment and blueprint validation. As described herein, techniques of the disclosure introduce a comprehensive, data-driven approach to wireless network deployment that significantly reduces manual effort and enhances the accuracy of access point (AP) placement. These and other techniques described herein can significantly reduce manual effort, improve the accuracy of AP placements, and enhance overall network performance, providing a seamless and intelligent deployment experience for network installers, administrators, and users.

Illustratively, the techniques described herein may be performed by hardware, software, and/or firmware, (e.g., an “apparatus”) such as in accordance with the AP locating process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
obtaining, by a process, a floorplan of a given location within which one or more access points are to be installed;
determining, by the process and based on historical information, effects of environmental features within the given location on wireless communication coverage based on the floorplan;
determining, by the process, specific placement of each of the one or more access points within the given location to maximize the wireless communication coverage based on the effects; and
producing, by the process, a recommendation of the specific placement on the floorplan.

2. The method of claim 1, further comprising:
determining, by the process, a location of a particular access point of the one or more access points after installation of the particular access point;
validating, by the process, the location of the particular access point after installation against the recommendation of the specific placement on the floorplan; and
generating, by the process, an incremental report that either confirms the location of the particular access point against the recommendation or alerts that the location of the particular access point is different than the recommendation.

3. The method of claim 1, further comprising:
performing one or more tests involving a particular access point installed according to the recommendation of the specific placement on the floorplan;
determining, based on a result of the one or more tests, that the particular access point is experiencing an unexpected condition;
determining, by the process, a new placement for the particular access point in response to the result of the one or more tests; and
providing, by the process, a new recommended placement for deployment of the particular access point.

4. The method of claim 1, further comprising:
determining, by the process, a calculated number of access points to use within the given location based on the floorplan and the effects.

5. The method of claim 1, further comprising:
determining, by the process, a pre-configured number of access points to be deployed within the given location; and
determining, by the process, the specific placement of each of the one or more access points given the pre-configured number of access points to be deployed within the given location.

6. The method of claim 1, wherein the specific placement is determined based on information selected from a group consisting of: a determined configuration of the one or more access points, a determined type of the one or more access points, and the determined configuration of the one or more access points and the determined type of the one or more access points.

7. The method of claim 1, further comprising:
determining, by the process, a pre-set budget for deploying the one or more access points within the given location; and
determining, by the process and based at least in part on the pre-set budget, one or more of: a calculated number of access points to use within the given location, a type of the one or more access points, and a configuration of the one or more access points.

8. The method of claim 1, wherein the one or more access points to be installed are additional access points to an existing deployment of previously installed access points within the given location.

9. The method of claim 1, wherein the one or more access points to be installed are new access points for a new deployment within the given location without keeping any previously installed access points at the given location.

10. The method of claim 1, wherein the one or more access points to be installed comprise at least one upgraded replacement access point for one or more existing access points of an existing deployment within the given location.

11. The method of claim 1, wherein the floorplan of the given location comprises a changed floorplan as compared to a previous floorplan of the given location, and wherein the one or more access points to be installed comprise existing access points of an existing deployment within the given location.

12. The method of claim 1, further comprising:
processing, using machine learning techniques, a plurality of access point deployments within various floorplan designs to determine guidance for successful access point deployment, wherein the historical information includes the guidance for successful access point deployment as applied to the floorplan of the given location.

13. The method of claim 1, wherein the historical information includes environmental information based, at least in part, on observations from a legacy access point deployment within the given location.

14. The method of claim 1, wherein the historical information includes access point coverage information that is based, at least in part, on signal strength measurements, client connection patterns, ranging data, or any combination thereof.

15. The method of claim 1, wherein the historical information includes information corresponding to expected access point behavior based on specifications associated with a particular access point, expected access point behavior based on simulations associated with the particular access point, or any combination thereof.

16. A tangible, non-transitory, computer-readable medium storing program instructions that cause a device to execute a process comprising:
obtaining a floorplan of a given location within which one or more access points are to be installed;
determining, based on historical information, effects of environmental features within the given location on wireless communication coverage based on the floorplan;
determining specific placement of each of the one or more access points within the given location to maximize the wireless communication coverage based on the effects; and
producing a recommendation of the specific placement on the floorplan.

17. The tangible, non-transitory, computer-readable medium of claim 16, wherein the program instructions cause the device to execute a process comprising:
determining, by the process, a location of a particular access point of the one or more access points after installation of the particular access point;
validating, by the process, the location of the particular access point after installation against the recommendation of the specific placement on the floorplan; and
generating, by the process, an incremental report that either confirms the location of the particular access point against the recommendation or alerts that the location of the particular access point is different than the recommendation.

18. The tangible, non-transitory, computer-readable medium of claim 16, wherein the program instructions cause the device to execute a process comprising:
performing one or more tests involving a particular access point installed according to the recommendation of the specific placement on the floorplan;
determining, based on a result of the one or more tests, that the particular access point is experiencing an unexpected condition;
determining, by the process, a new placement for the particular access point in response to the result of the one or more tests; and
providing, by the process, a new recommended placement for deployment of the particular access point.

19. The tangible, non-transitory, computer-readable medium of claim 16, wherein the floorplan of the given location comprises a changed floorplan as compared to a previous floorplan of the given location, and wherein the one or more access points to be installed comprise existing access points of an existing deployment within the given location.

20. An apparatus, comprising:
one or more network interfaces to communicate with a network;
a processor coupled to the one or more network interfaces and configured to execute one or more processes; and
a memory configured to store a process that is executable by the processor, the process comprising:
obtaining a floorplan of a given location within which one or more access points are to be installed;
determining, based on historical information, effects of environmental features within the given location on wireless communication coverage based on the floorplan;
determining specific placement of each of the one or more access points within the given location to maximize the wireless communication coverage based on the effects; and
producing a recommendation of the specific placement on the floorplan.
